(19) United States
(12) Patent Application Publication
(10) Pub. No.: US 2006/0280113 A1
(43) Pub. Date: Dec. 14, 2006

(54) Method and apparatus for dynamic allocation of pilot symbols

(76) Inventor: David Di Huo, Newton, NJ (US)

Correspondence Address: Michael G. Fletcher;FLETCHER YODER, P.O. Box 692289, Houston, TX, 77269-2289, US

(21) Appl. No.: 11/150,634

(22) Filed: Jun. 10, 2005

(51) Int. Cl. H04J 11/00

(52) U.S. Cl. 370/208

(57) ABSTRACT

There is provided a method and apparatus for dynamic allocation of pilot symbols in an OFDM transmission. More specifically, there is provided a method comprising transmitting a first orthogonal frequency division multiplexed signal with a first pilot symbol allocation, receiving a metric indicative of the quality of a transmitted signal, changing the location of pilot symbols within the first pilot symbol allocation based on the metric to create a second pilot symbol allocation, and transmitting a second orthogonal frequency division multiplexed signal with the second pilot symbol allocation.

### BACKGROUND OF THE INVENTION

1. Field of the Invention

The present invention relates generally to telecommunications and, more particularly to wireless communications.

2. Description of the Related Art

This section is intended to introduce the reader to various aspects of art that may be related to various aspects of the present invention, which are described and claimed below. This discussion is believed to be helpful in providing the reader with background information to facilitate a better understanding of the various aspects of the present invention. Accordingly, it should be understood that these statements are to be read in this light, and not as admissions of prior art.

One of the paramount challenges facing modern telecommunication systems is the rapid growth of customer demand for telecommunications services provided by the Internet, the cellular telephone system, or other mechanisms. In fact, consumers are demanding greater access to information and information-related services than ever before, and this trend is not likely to change. For example, in the coming years, consumers are likely to expect even more enhanced services, such as Internet-based movie rental and cellular telephone video conferencing.

Unfortunately, building or upgrading the telecommunication infrastructure to support growing consumer demand is relatively expensive. As such, much research has been invested into determining better and more efficient methods for transmitting information over existing infrastructure. Early designs used multiple frequencies to transmit multiple signals simultaneously. One such technique, which came to be known as frequency division multiplexing, provides each signal (e.g., each user) its own frequency range, which is referred to as a sub-carrier. To reduce interference, however, each of these sub-carriers is typically separated from the other sub-carriers by a guard band frequency, which occupies a frequency range that could otherwise be employed to transmit additional information.

One solution to this problem is known as orthogonal frequency division multiplexing (“OFDM”). OFDM is similar to frequency division multiplexing except that the sub-carriers are orthogonal and overlapping. Because orthogonal frequencies are perpendicular to one another in a mathematical sense, sub-carriers with orthogonal frequencies can overlap without creating much interference. As such, OFDM enables more efficient use of a transmission spectrum than frequency division multiplexing with guard band frequencies. For this reason, OFDM has been adopted into various standards, including, for example, digital audio broadcast (“DAB”), digital video broadcast (“DVB”), asymmetric digital subscriber line (“ADSL”), IEEE LAN (802.11a and 802.11g), and IEEE MAN 802.16a. OFDM modulation is also being considered for next generation cellular and wireless systems, such as 3 G, 3.5 G, and 4 G.

One of the constant challenges in transmitting information is compensating for the effects of “the channel.” The channel includes the net effect of environmental factors, such as the weather, the earth's magnetic fields, terrain variations, structures, and/or vehicles on the electromagnetic signal as it travels through the air or another transmission medium from one device to another. To convert such a signal back into a voice or other useful data, a receiver estimates the channel to compensate for the channel's effects on the signal. If the receiver were able to make a perfect estimate of the channel, the receiver could convert the received signal back into an exact copy of the transmitted signal. Unfortunately, it is virtually impossible to estimate the channel perfectly. Thus, the receiver is typically not able to compensate completely for the channel and some distortion or errors are typically introduced. These errors may be measured with a signal-to-noise ratio (“SNR”), a frame error rate (“FER”), and/or another suitable metric. For example, a SNR of 99% indicates that only one percent of the intended signal has been lost due to the effect of the channel.

One technique for estimating the channel is to use pilot symbols. Pilot symbols are “known” symbols that the receiver can use to estimate the channel. In particular, because the receiver is preprogrammed with the pilot symbols, the receiver can estimate the channel by comparing the transmission it actually receives with the “known” symbol that the receiver ideally should have received. Because the channel is constantly changing, pilot symbols are continually transmitted from the transmitter to the receiver. Further, because the channel varies with frequency, pilot symbols are also transmitted across a wide range of frequencies or sub-carriers.

Though pilot symbols enable more accurate estimation of the channel, this improved estimation comes at a price. Namely, there is a fixed bandwidth available for transmitting data and any bandwidth used to transmit pilot symbols is not available to transmit other (non-pilot) information. In this way, there is a relationship between the quality of the channel estimation (e.g., the more pilot symbols, the high the quality of the estimation) and the amount of non-pilot information (e.g., user data) that can be transmitted across the channel.

Conventional OFDM-based systems select the number of pilot symbols and the pilot symbol allocation within the sub-carrier when the transmitter and the receiver first make contact. If, however, channel conditions change during subsequent transmissions (e.g., later in a conversation), the number of pilot symbols or the allocation of pilot symbols may either become either insufficient or inefficient to maintain a desired signal-to-noise ratio (“SNR”). A system that could dynamically allocate pilot symbol transmissions in OFDM-based systems would be advantageous.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In one embodiment, there is provided a method comprising transmitting a first orthogonal frequency division multiplexed signal with a first pilot symbol allocation, receiving a metric indicative of the quality of a transmitted signal, changing the location of pilot symbols within the first pilot symbol allocation based on the metric to create a second pilot symbol allocation, and transmitting a second orthogonal frequency division multiplexed signal with the second pilot symbol allocation.

In another embodiment, there is provided a device comprising a module configured to map pilot and non-pilot symbols into a plurality of sub-carriers within an orthogonal frequency division multiplexing transmission resource based on a first pilot symbol allocation, a module configured to receive a metric from a receiver indicative of transmission errors, and a module configured to map pilot and non-pilot symbols into a plurality of sub-carriers within the orthogonal frequency division multiplexing transmission resource based on a second pilot symbol allocation, wherein the device selects the second pilot symbol allocation based on the metric.

### BRIEF DESCRIPTION OF THE DRAWINGS

Advantages of the invention may become apparent upon reading the following detailed description and upon reference to the drawings in which:

FIG. 1 illustrates an exemplary cellular system in accordance with an embodiment of the present invention;

FIG. 2 illustrates an exemplary OFDM transmitter and an exemplary OFDM receiver in accordance with an embodiment of the present invention;

FIG. 3 is a flow chart illustrating an exemplary technique for dynamically allocating pilot symbols in accordance with an embodiment of the present invention;

FIG. 4 illustrates an exemplary OFDM transmission resource pattern for one exemplary channel condition in accordance with embodiments of the present invention;

FIG. 5 illustrates an exemplary OFDM transmission resource pattern for a channel condition more degraded than the channel condition in FIG. 4 in accordance with embodiments of the present invention; and

FIG. 6 illustrates and exemplary OFDM transmission resource pattern for a channel condition more degraded than the channel condition in FIG. 5 in accordance with embodiments of the present invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions should be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The embodiments described herein are directed towards a system or a method for dynamically allocating pilot symbols in an orthogonal frequency division multiplexing (“OFDM”) system. Specifically, in one embodiment, a transmitter may periodically adjust the number of pilot symbols or the allocation of pilot symbols within the OFDM transmission resource to maintain a target signal-to-noise ratio (“SNR”), a target frame error rate (“FER”), or other suitable signal quality metric.

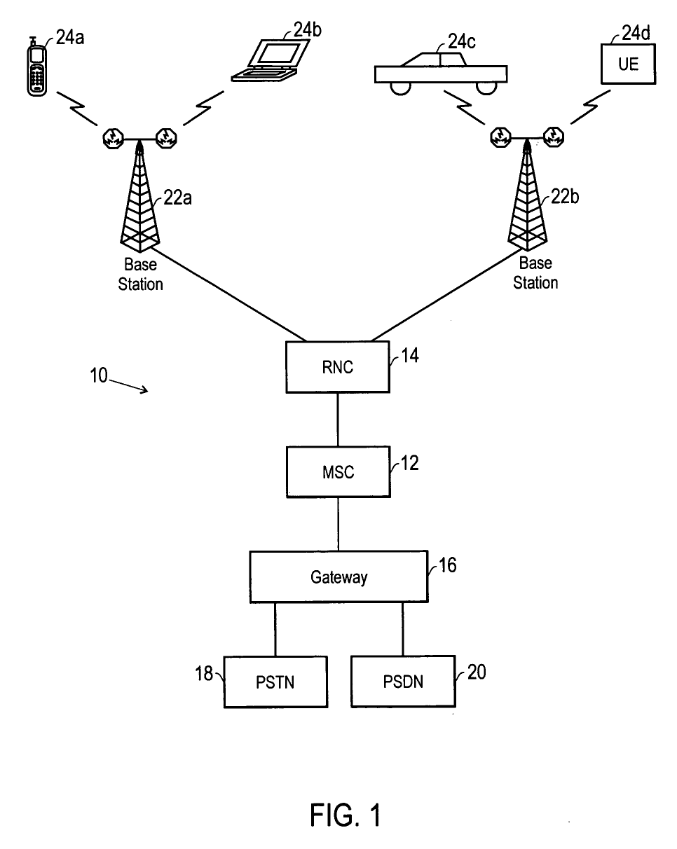

Turning now to the drawings, and referring initially to FIG. 1, an exemplary cellular system is illustrated and designated by a reference numeral 10. Those of ordinary skill in the art will appreciate that the cellular system 10, described below, illustrates merely one embodiment of a system configured to dynamically allocate pilots symbols in an OFDM system. While not described in detail, those of ordinary skill in the art will appreciate that the techniques described herein may be employed in a wide variety of OFDM systems. Examples of other suitable types of OFDM systems include, but are not limited to, digital audio broadcast (“DAB”), digital video broadcast (“DVB”), asymmetric digital subscriber line (“ADSL”) IEEE LAN (802.11a and 802.11g), IEEE MAN 812.16a (“WiMAX”), and a variety of possible next generation wireless systems such as 3G, 3.5G, and 4G.

In any given wireless telephone market, such as a typical metropolitan area, the wireless telephone system 10 may include at least one mobile switching center (“MSC”) 12. The MSC 12 is a switch that serves the wireless telephone system 10. The primary purpose of the MSC 12 is to provide a voice path and/or a data path between a mobile device and another telephone or data source. The typical MSC 12 includes a number of devices, such as computerized call routers, that control switching functions, call processing, channel assignments, data interfaces, tracking, paging, call handoff, and user billing. The MSC 12 may be coupled to a gateway 16, which in turn may be coupled to a public switched telephone network (“PSTN”) 18, which is often referred to as a land line telephone network. The wireless telephone system 10 typically includes a connection to the PSTN 18, because a majority of all wireless telephone calls pass through the PSTN 18. The gateway 16 may also be coupled to a packet switch data network (“PSDN”) 20, such as the Internet, so as to provide Internet service to wireless telephone users.

One or more radio network controllers (“RNC”) 14 may also be coupled to the MSC 12. The RNC 14 may control the use and reliability of radio resources within the wireless telephone system 10. Specifically, the RNC 14 may control the allocation and release of specific radio resources to establish a connection between mobile devices (see below) and the MSC 12.

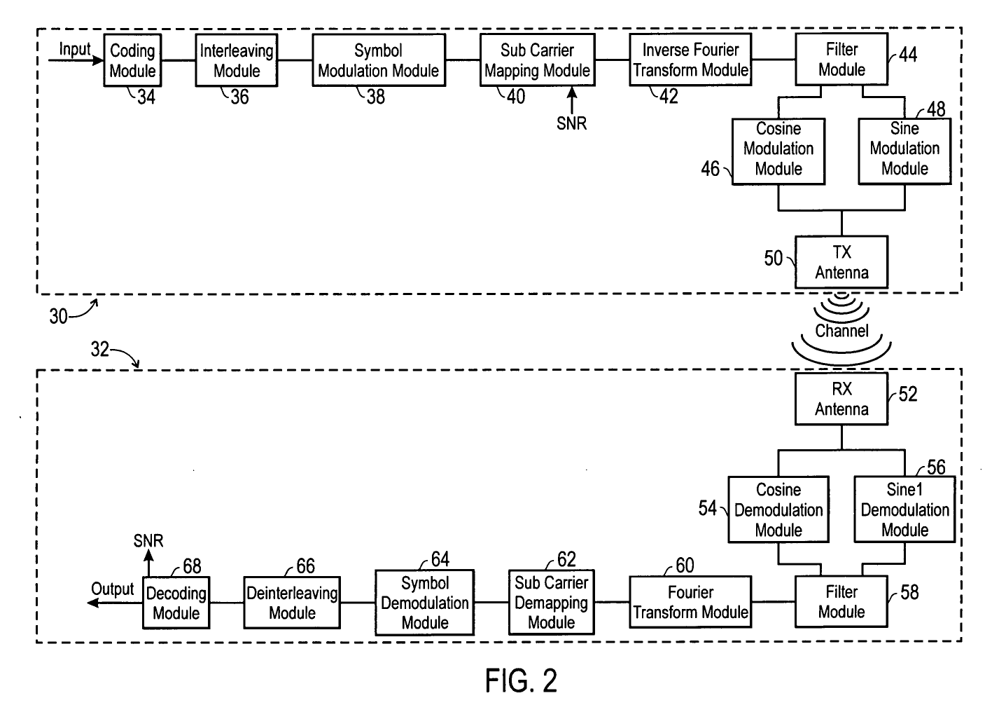

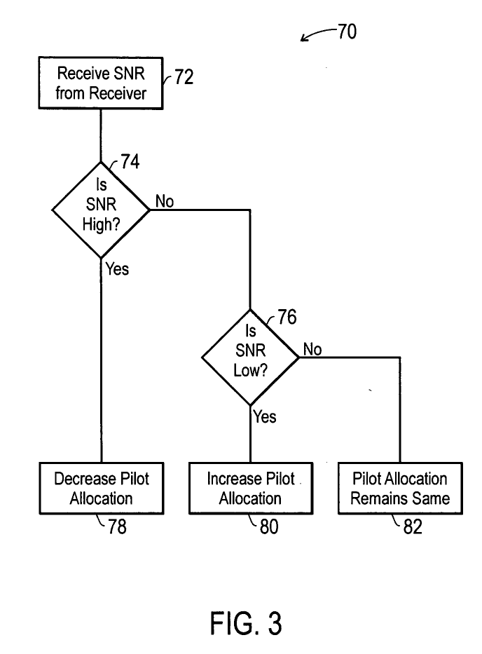

The RNC 14 may be communicatively coupled either by wire or wirelessly to one or more base stations 22a and 22b. The base stations 22a and 22b are transmission and reception stations that act as access points for network traffic from a variety of mobile devices 24a, 24b, 24c, and 24d. As such, the base stations 22a and 22b may communicate voice or data with any suitable mobile device, such as a portable wireless telephone 24a, a laptop computer 24b, a vehicle system 24c, or other user equipment 24d. While only two base stations 22a and 22b are illustrated in FIG. 1, those of ordinary skill in the art will appreciate that any suitable number of base stations 22a and 22b may be coupled to the RNC 14. Further, it should be understood that the RNC 14 and/or the base stations 22a and 22b, may include, among other things, an OFDM transmitter, an OFDM receiver, or both, as will be described further below with regard to FIGS. 2 and 3.

FIG. 2 illustrates an exemplary OFDM transmitter 30 and an exemplary OFDM receiver 32 in accordance with one embodiment. The OFDM transmitter 30 may be fully or partially disposed within the RNC 14, the base station 22a and 22b, or the wireless devices 24a-24d. Similarly, the OFDM receiver 32 may be disposed, wholly or partially within the RNC 14, the base stations 22a and 22b, or the wireless devices 24a-24d. As illustrated in FIG. 2, the OFDM transmitter 30 includes various modules or components as represented by blocks 34, 36, 38, 40, 42, 44, 46 and 48 and the OFDM receiver 32 includes various modules or components as represented by blocks 54, 56, 58, 60, 62, 64, 66, and 68. The blocks 34, 36, 38, 40, 42, 44, 46, 48, 54, 56, 58, 60, 62, 64, 66, and 68 may be performed by hardware, software, firmware, or some combination of hardware, software, and firmware. Additionally, an individual block does not necessarily solely contain each illustrated module. The blocks are merely one example and other examples can be envisaged wherein the module functions are distributed differently or where some modules are included and other modules are not included. For example, in one alternate embodiment, the modules illustrated in FIG. 2 may be consolidated or rearranged to create a transceiver capable of both receiving and transmitting OFDM modulated signals.

As illustrated in FIG. 2, the coding module 34 receives an input to be transmitted. In one embodiment, the input is a packet of digital information or an encoded voice transmission, for example. The coding module 34 encodes the packet. Coding may involve adding additional error correction bits to the transmission, for example. The additional error correcting bits allow errors to be detected or corrected by a receiver, thus reducing the amount of information that has to be retransmitted. Those of ordinary skill in the art will appreciate that a variety of suitable coding schemes, such as turbo coding, convolution coding, or LEPC coding, may be employed by the coding module 34.

The encoded packet is then transmitted to the interleaving module 36. The interleaving module 36 interleaves (i.e., shuffles or rearranges) the order of the bits within the encoded packet. Those of ordinary skill in the art will appreciate that shuffling the order of the bits decreases the possibilities that a single disturbance during transmission will result in an uncorrectable error. Specifically, shuffling the order of the bits to be transmitted essentially distributes any interference in the channel amongst all the bits being transmitted. In this way, interleaving increases the probabilities that transmission errors can be corrected during decoding (see below).

The interleaved signal is transmitted from the interleaving module 36 to the symbol modulation module 38. Those of ordinary skill in the art will appreciate that a symbol is a “package of bits.” The size of this package of bits may be determined by the number of possible states that the phase of the signal can take in a particular modulation scheme. For example, in the modulation scheme known as phase-shift keying (“PSK”), a symbol contains one bit, because the a PSK-modulated signal can take one of two states, zero or one. In alternate modulation schemes, such as QSPK, 8 SPK, 16 QAM, 32 QAM, and 64 QAM, a symbol may contain 2, 4, 8, 16, 32, and 64 bits, respectively. Those of ordinary skill in the art will appreciate that because modulation includes converting digital bits into an analog signal with a constant amplitude and a phase that varies based on the encoded digital signal, the output from the symbol modulation module 38 includes a complex number, which is referred to as a complex symbol.

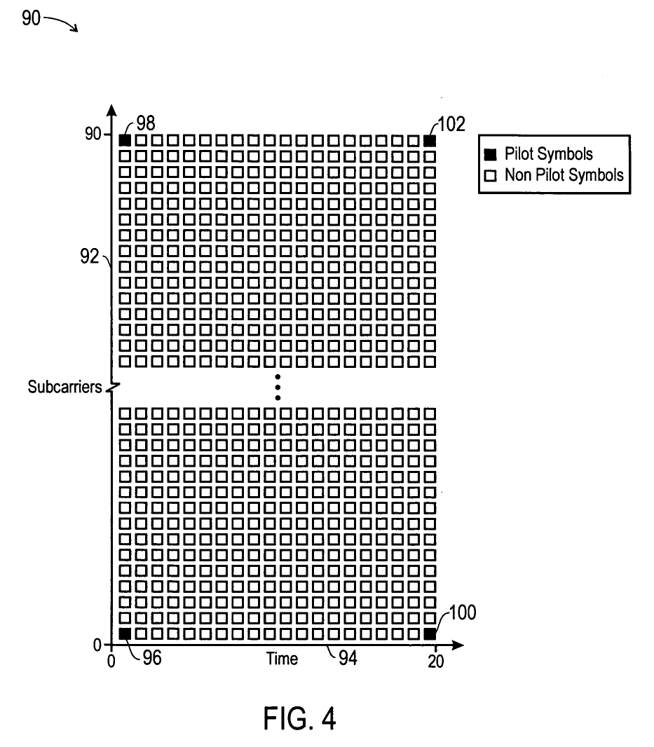

Each of these complex symbols is transmitted from the symbol modulation module 38 to the sub-carrier mapping module 40. Those of ordinary skill in the art will appreciate that the OFDM transmission resource can be visualized as a graph with the available sub-carriers (i.e., frequencies) arrayed along the vertical axis and time arrayed along the horizontal access (see FIGS. 4, 5, and 6). Each sub-carrier has a capability to transmit a predetermined number of symbols over a predetermined amount of time. This capacity can be envisaged as a series of slots for each sub-carrier (illustrated as boxes in FIGS. 4, 5, and 6) with each slot being able to “hold” one symbol to be transmitted. Accordingly, the sub-carrier mapping module 40 is configured to map the complex symbols generated by the symbol modulation module 38 to the available slots within the OFDM transmission resource.

The sub-carrier mapping module 40 may also be configured to map pilot symbols to one or more of the slots within the OFDM transmission resource. For this reason, the OFDM transmission resource can be represented as a pattern of boxes that each contains either a pilot or non-pilot symbol. As will be described further below, the sub-carrier mapping module 40 may vary the number of pilot symbols and the allocation of pilot symbols within the OFDM transmission resource based on an SNR communicated back to the OFDM transmitter 30 by a receiver (e.g., the OFDM receiver 32). Those of ordinary skill in the art will appreciate that wireless receivers are typically configured to calculate the SNR for received signals and to transmit this SNR back to the OFDM transmitter 30.

After the sub-carrier mapping module 40 has mapped sub-carriers into the OFDM resource pattern, the inverse Fourier transform module 42 transforms the complex symbols within the sub-carriers from the frequency domain to the time domain via an inverse Fourier transform. Those of ordinary skill in the art will appreciate that each of the complex symbols includes a real part and an imaginary part. Accordingly, the inverse Fourier transform module 42 performs an inverse Fourier transform on both the real part and the imaginary part forming two separate time domain signals. The time domain signals are then transmitted to the filter module 44, which shapes the pulses transmitted by the inverse Fourier transform module 42 into a smooth-shaped wave form. After filtering, the (formerly) real part of the signal is transmitted to the cosine modulation module 46, and the (formerly) imaginary part of the signal is transmitted to the sine modulation module 48. Those of ordinary skill in the art will appreciate that modulating the real part of the signal by cosine and the imaginary part of the signal by sine allows the real part of the signal and the imaginary part of the signal to be simultaneously transmitted with little interference, because the cosine function and the sine function are orthogonal. After sine and cosine modulation, the modulated signals are transmitted to a transmission antenna 50, which transmits the signal wirelessly into the channel (e.g., the air).

After transmission, the transmitted signal will travel through the channel (i.e., the air) to the OFDM receiver 32. The OFDM receiver will receive the transmitted signal via a reception antenna 52. Once received, the signal will be transmitted to the cosine demodulation module 54 and the sine demodulation module 56. The cosine demodulation module 54 generates the real part of the transmitted signal and the sine demodulation module 56 generates the imaginary part of the transmitted signal. The real and imaginary parts are then transmitted into the filter module 58, which converts the smooth-shaped wave form into a series of pulses that can be transformed back into the frequency domain by the Fourier transform module 60. The frequency domain signal is then transmitted to the sub-carrier mapping module 62, which converts the frequency domain signal from mapped sub-carriers into a series of symbols.

The series of symbols is then transmitted to the symbol demodulation module 64, which converts the symbols into a series of bits. Those of ordinary skill in the art will appreciate that the symbol demodulation module 64 may use the pilot symbols within the series of symbols to estimate the effects of the channel on each of the non-pilot symbols. Because the effects of the channel vary across the OFDM resource, the symbol demodulation module 64 may estimate the effects of the channel for each transmission slot using an interpolation methodology, such as the Spline algorithm or means-squared-error. In other words, the symbol demodulation module 64 may interpolate the channel conditions for the non-pilot symbols based on the pilot symbols. This form of interpolation is generally known to those of ordinary skill in the art.

Once the symbols have been converted into a series of bits, the de-interleaving module 66 reverses the effects of the interleaving module 36 by reshuffling the bits into their original order. Once deinterleaved, the bits are transmitted to the decoding module 66 which detects and corrects errors and removes the additional bits added by the coding module 34 in the OFDM transmitter 30. The decoding module 68 may note any errors that are uncorrectable and may compute the SNR, the frame error rate (“FER”), and/or another suitable signal quality metric for the transmission based on those uncorrectable errors. In the illustrated embodiment, the decoding module 68 transmits the SNR to a transmitter (not shown) for transmission back to the sub-carrier mapping module 40 within the OFDM transmitter 30. In alternate embodiments, the SNR may be computed elsewhere within the OFDM receiver 32.

After the decoding module 68 is finished decoded, the original signal (e.g., the packet) has been reconstituted and is transmitted from the OFDM receiver 32 as an output. For example, if the OFDM receiver 32 is disposed within the cellular telephone 24a, the decoding module 68 may transmit the output to a module (not shown) that converts the output to a voice or to a module (not shown) that displays the output on a screen.

FIG. 3 is a flowchart illustrating an exemplary technique 70 for dynamically allocating pilot symbols in accordance with one embodiment. In one embodiment, the sub-carrier mapping module 40 within the OFDM transmitter 30 performs the technique 70. As illustrated, the OFDM transmitter 30 may begin by receiving a signal noise ratio (“SNR”) from the OFDM receiver 32, as illustrated in block 72. Once the SNR has been received, the sub-carrier mapping module 40 determines whether the SNR is above a predetermined threshold, as indicated in block 74. In one embodiment, the SNR will be above the predetermined threshold if the SNR is above 98.5%. If the SNR is high, the pilot symbol allocation will be decreased, as indicated in block 78. For example, in one embodiment, the pilot allocation may be decreased one step in an order plurality of predetermined pilot symbol allocations unless the pilot allocation is already at the lowest step. In alternate embodiments, the pilot symbol allocation may be decreased to any suitable pilot allocation.

Returning to block 74, if the SNR is not high, the sub-carrier mapping module 40 may determine whether the SNR is low, as indicated in block 76. In one embodiment, the SNR will be determined to be low, if the SNR is below 97.5%. If the SNR is low, the technique 70 will increase the pilot allocation as indicated in block 80. As will be described further below, in one embodiment increasing the pilot allocation may include increasing the pilot symbol allocation by one step in the ordered plurality of predetermined pilot symbol allocations unless the pilot allocation is already at the highest level. In alternate embodiments, the pilot symbol allocation may be increased to any suitable pilot allocation. Returning to block 76, if the SNR is not low (i.e., the SNR is neither high nor low), the pilot allocation will remain unchanged, as indicated in block 82.

The sub-carrier mapping module 40 within the OFDM transmitter 30 may periodically perform the technique 70 to vary the number of pilot symbols within the OFDM transmission depending on the channel conditions. For example, in one embodiment, the sub-carrier mapping module 40 may be repeated and the pilot symbol allocation changed once every 1.25 seconds within a communication session (e.g., a phone call or text-messaging session). In another embodiment, the technique 70 may be repeated once every frame. Those of ordinary skill in the art will appreciate, however, that these periods are merely exemplary, and that in still other embodiments, transmitter 30 may perform the technique 70 at any suitable interval.

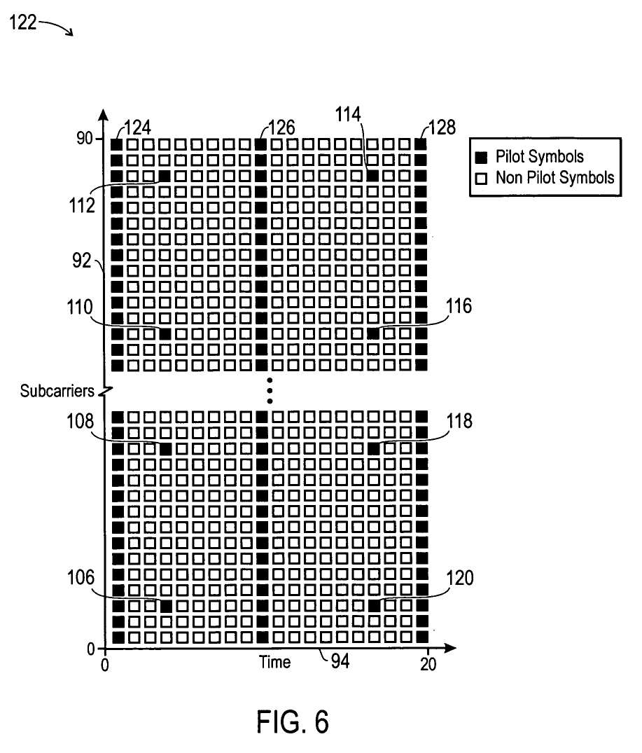

Turning next to pilot symbol allocation within the OFDM transmission resource, those of ordinary skill in the art will appreciate that the OFDM transmission resource can be represented as a series of sub-carriers, which each contain a series of slot each of which can transmit a single symbol. Pilot symbols and non-pilot symbols (e.g., user data) are mapped into the slots in the sub-carriers and then transmitted. Those of ordinary skill in the art will appreciate OFPM transmission resource can be represented as a pattern of pilot and non-pilot symbols (see FIGS. 4, 5, and 6). As described above in regard to FIGS. 2 and 3, the sub-carrier mapping module 40 may dynamically alter the number or pattern of pilot symbols based on the SNR. In one embodiment, the sub-carrier mapping module 40 is preprogrammed with a plurality of pilot/non-pilot symbol patterns. For example, the sub-carrier mapping module 40 may store ten different patterns, varying from patterns that have no pilot symbols to patterns where a plurality of time slots or sub-carriers are contain exclusively pilot symbols (see FIG. 6). This plurality of symbol patterns can be arranged into an ordered list based on the number of slots allocated to pilot symbols (e.g., the fewest pilot symbols to the most pilot symbols). Once arranged, the sub-carrier mapping module 40 can dynamically allocate the number of pilot symbols by moving either up or down on the list of preprogrammed pilot symbol patterns.

In an alternate embodiment, a pattern generator may be programmed to dynamically generate additional symbols patterns, when needed, by executing a mathematical operation on the current pilot allocation pattern. For example, if the SNR is low, the pilot generator may be configured to increase the number of pilot symbols by a percentage equivalent to the SNR and then to distribute the added pilot symbols randomly in the OFDM transmission resource to create a new pattern. Those of ordinary skill in the art will appreciate that the two examples of pattern generation discussed above are merely exemplary and not intended to be exclusive. Accordingly, in still other embodiments, the pilot symbol allocation may be increased or decreased in any suitable manner or pattern.

Those of ordinary skill in the art will appreciate that the condition of the channel may vary for a number of reasons including magnetic fields or obstacles. For example, a thunderstorm may produce high magnetic fields that greatly degrade the channel conditions. In such degraded conditions, the channel conditions may change quickly are may vary considerably amongst the various sub-carriers. On the contrary, on a clear day, the channel conditions for a relatively few sub-carriers within the OFDM transmission resource may be sufficient to predict the channel conditions for all of the sub-carriers within the OFDM transmission resource. Likewise, on a clear day, the channel conditions are one point in time may be sufficient to predict the channel conditions for a relatively long period of time (e.g., 1 second). As described below, FIGS. 4, 5, and 6 represent three exemplary pilot symbols allocations that are suitable for use with three representation channel conditions. Those of ordinary skill in the art will appreciate that the three pilot symbol allocations are merely exemplary. Those of ordinary skill in the art will appreciate that there are hundreds, if not thousands, of possible pilot symbol allocations that could employed depending on the channel conditions and the desired signal quality.

Looking first at an exemplary pilot symbol allocation for a fairly stable channel condition, FIG. 4 illustrates an exemplary OFDM transmission resource pattern 90 in accordance with one embodiment. As described above, the pattern 90 includes a plurality of sub-carriers (rows) along a vertical axis 92 that are each divided into a series slots (boxes) based on a time period (axis 94) that it takes to transmit one symbol. The pattern 90 includes a 90×20 grid of slots (i.e., 90 sub-carriers divided into 20 time periods). As illustrated, the pattern 90 includes four pilot symbols 96, 98, 100, and 102 located respectively at (0,0), (0,90), (20,0), and (20,90). The pattern 90 may be applied in conditions where the channel is stable or changing relatively slowly because a stable channel has less variety between frequencies (i.e., sub-carriers) or for the same sub-carrier through time. As such, a relatively few pilot symbols are sufficient to estimate the channel conditions for the OFDM transmission resource.

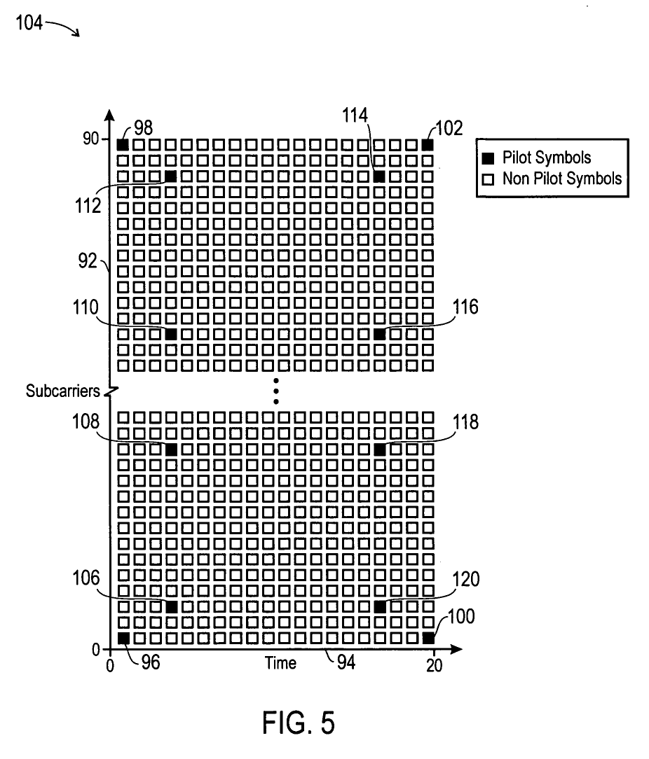

Looking next to a pilot symbol allocation for a slightly more degraded channel condition, FIG. 5 illustrates an exemplary OFDM transmission resource pattern 104 for a more degraded channel condition than the channel condition in illustrated in FIG. 4 in accordance with one embodiment. It will be appreciate that a more degraded channel condition may occur if there is relatively greater variation in channel conditions between sub-carriers or greater variation in channel conditions across time or both) As illustrated, the pattern 104 includes eight additional pilot symbols 106, 108, 110, 112, 114, 116, 118, and 120 than the pattern 90. As described above, the additional pilot symbols 106-120 provide additional measurements of the channel, which can be used to improve the channel estimate.

Turning next to a pilot symbol allocation for a highly degraded channel condition, FIG. 6 illustrates an exemplary OFDM transmission resource pattern 122 for a channel condition even more degraded than the channel condition in FIG. 5 in accordance with an embodiment. As illustrated in FIG. 6, the pattern 122 includes entire time periods 124, 126, and 128 where each of the ninety sub-carriers is used to transmit pilot symbols. While dedicating entire time periods to pilot symbols reduces the number of non-pilot symbols that can be transmitted in the cellular system 10, the pattern 122 or another similar pattern may be the most efficient way to maintain the SNR if the channel conditions are particularly degraded.

As stated above, the exemplary OFDM transmission resources patterns 90, 104, and 122 illustrated in FIGS. 4, 5, and 6 are merely examples of suitable OFPM transmission resource patterns. In alternate embodiments, virtually any suitable pilot symbol pattern may be employed in the cellular system 10. For example, in one embodiment, the sub-carrier mapping module 40 of the OFDM transmitter 30 stores ten pilot allocations varying from patterns with relatively few pilot symbols like the pattern 90 to patterns with relatively many pilot symbols similar to the pattern 122. In another embodiment, the OFDM transmitter 30 may comprise tens, hundreds, or more transmission resource patterns or a mathematical function that enables the OFDM transmitter 30 to generate a virtually unlimited number of transmission resource patterns.

Many of the modules, functions, or blocks described above with reference to FIGS. 2 and 3 may comprise a listing of executable instructions for implementing logical functions. Such a listing can be embodied in a computer-readable medium for use by or in connection with a computer-based system that can retrieve the instructions and execute them to carry out the previously described processes. In the context of this application, the computer-readable medium can contain, store, communicate, propagate, transmit or transport the instructions. By way of example, the computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette, a random access memory (RAM) a read-only memory (ROM), an erasable programmable read-only memory (EPROM or Flash memory), an optical fiber, and a portable compact disk read-only memory (CDROM). It is even possible to use paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

We claim:

1. A method comprising:
transmitting a first orthogonal frequency division multiplexed signal with a first pilot symbol allocation;
receiving a metric indicative of the quality of a transmitted signal;
changing the location of pilot symbols within the first pilot symbol allocation based on the metric to create a second pilot symbol allocation; and
transmitting a second orthogonal frequency division multiplexed signal with the second pilot symbol allocation.

2. The method, as set forth in claim 1, wherein the transmitting the second signal comprises transmitting a second signal during the same communication session as the first signal was transmitted.

3. The method, as set forth in claim 1, wherein receiving the metric comprises receiving a signal-to-noise ratio.

4. The method, as set forth in claim 3, changing the location of pilot symbols comprises increasing the number of pilot symbols if the signal-to-noise ratio is below a predetermined threshold.

5. The method, as set forth in claim 3, wherein changing the location of pilot symbols comprises decreasing the number of pilot symbols if the signal-to-noise ratio is above a predetermined threshold.

6. The method, as set forth in claim 1, wherein receiving the metric comprises receiving a frame error rate.

7. A device comprising:
a module configured to map pilot and non-pilot symbols into a plurality of sub-carriers within an orthogonal frequency division multiplexing transmission resource based on a first pilot symbol allocation;
a module configured to receive a metric from a receiver indicative of transmission errors; and
a module configured to map pilot and non-pilot symbols into a plurality of sub-carriers within the orthogonal frequency division multiplexing transmission resource based on a second pilot symbol allocation, wherein the device selects the second pilot symbol allocation based on the metric.

8. The device, as set forth in claim 7, wherein the device comprises a module configured to select the second pilot symbol allocation based on a signal-to-noise ratio metric.

9. The device, as set forth in claim 8, wherein the device comprises a module configured to select a second pilot symbol allocation with more pilot symbols than the first pilot symbol allocation if the signal-to-noise ratio exceeds a preset level.

10. The device, as set forth in claim 8, wherein the device comprises a module configured to select a second pilot symbol allocation with less pilot symbols than the first pilot symbol allocation if the signal-to-noise ratio is below a preset level.

11. The device, as set forth in claim 7, wherein the device comprises a module configured to generate the second pilot symbol allocation based on the first pilot symbol allocation.

12. The device, as set forth in claim 7, wherein the device comprises a cellular base station.

13. A method comprising:
establishing a connection with a receiver;
transmitting first information to the receiver using orthogonal frequency division multiplexing, the first information comprising a first pilot symbol allocation;
receiving a metric from the receiver indicative of transmission errors; and
transmitting second information to the receiver using orthogonal frequency division multiplexing, the second information comprising a second pilot symbol allocation, wherein the second pilot symbol allocation is selected based on the metric.

14. The method, as set forth in claim 13, wherein receiving the metric comprises receiving a frame error rate.

15. The method, as set forth in claim 13, wherein receiving the metric comprises receiving a signal-to-noise ratio.

16. The method, as set forth in claim 15, wherein the transmitting using the second pilot allocation comprises transmitting using a pilot allocation that comprises more pilot symbols than the first pilot symbol allocation if the signal-to-noise ratio is less than a predetermined level.

17. The method, as set forth in claim 15, wherein the transmitting using the second pilot allocation comprises transmitting using a pilot allocation that comprises less pilot symbols than the first pilot symbol allocation if the signal-to-noise ratio exceeds a predetermined level.

18. The method, as set forth in claim 13, wherein transmitting using the second pilot allocation comprises transmitting using a pilot allocation selected from a plurality of preprogrammed pilot allocation patterns.

19. The method, as set forth in claim 13, wherein establishing a connection with the receiver comprises establishing an asymmetric digital subscriber line connection.

20. The method, as set forth in claim 13, wherein transmitting the second information comprising transmitting the second information to the receiver using orthogonal frequency division multiplexing, the second information comprising a second pilot symbol allocation, wherein the second pilot symbol allocation is selected from one of a plurality of pre-determined pilot symbol allocation patterns.
